(19) United States
(12) Patent Application Publication
(10) Pub. No.: US 2006/0123689 A1
(43) Pub. Date: Jun. 15, 2006

(54) Fishing lure fabricated with dichroic material

(76) Inventor: Michael Lange, Fort Lauderdale, FL (US)

Correspondence Address: Mark D. Bowen;Stearns Weaver Miller, et al., Suite 900, 200 East Broward Boulevard, Fort Lauderdale, FL, 33301, US

(21) Appl. No.: 11/013,052

(22) Filed: Dec. 15, 2004

(51) Int. Cl. A01K 85/00; A01K 85/01

(52) U.S. Cl. 43/42.32

(57) ABSTRACT

An improved fishing lure capable of presenting a unique visual impression by incorporation of a dichroic coating is disclosed. The dichroic coating provides a lure with unique visual properties including the appearance of having more than one color, especially when viewed from different angles or from transmitted to reflected light. The present invention thus provides a fishing lure incorporating dicrhoic coatings that transmit certain wavelengths of light, while reflecting others, thus creating an interference-effect similar to the iridescence observed in nature's fire opal, dragonfly wings and hummingbird feathers. The transmitted color is different than the reflected color, and when the light rays transmit straight through the glass they are less effected by refraction than when passing at an off axis angle, which make the light travel a greater distance through the glass. It is this distance that causes a color shift. When dichroic glass is viewed at even slightly different angles, a variety of different colors are seen.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to fishing lures, and more particularly to an artificial fish bait having a body portion incorporating dichroic glass so as to reflect and refract light in a manner that maximizes visibility and attraction to game fish.

2. Description of Related Art

The field of fishing lures is crowded with countless creative solutions to the numerous problems anglers have encountered in the field. The general philosophy underlying lure design is to provide a device that closely mimics the most attractive prey for the sought-after predatory species of fish. To that end, lures have been designed to mimic both the movements and the appearance of bait fish.

Many types of fishing lures are configured with materials, colors, and finishes designed to provide lures that resemble as closely as possible certain natural, live bait fish. In constructing a lure to resemble a natural species of minnow, or other natural food of the game fish, the finish placed on the lure is important. One technique which utilizes the phenomena of light reflectance to cause the lure to shine or appear like a natural bait species is to metallize the lure body by a vacuum metallizing process. Such metallizing places a thin layer of shiny metal, such as aluminum or nickel, in a finish on the outer side of the body of the lure. The metallized coating of the lure then causes it to reflect light in a way which to some degree resembles a “shiner” or small minnow. Another known technique for simulating natural species is the painting of minute scales on the body of the lure in simulation of the scales perceptible on a shad or minnow. Yet another known technique involves forming the lure with colorful glass or plastic material.

Examples of these various techniques are found throughout the art. For example, U.S. Pat. No. 4,862,631, issued to Wilson et al., discloses a fishing lure including a hard body having a light reflective metallic coating adjacent the body, and having a layer of small glass spheres overlying the metallic coating. U.S. Pat. No. 5,337,443, issued to Giray et al., discloses fishing weights made of glass. Giray discloses the use of various types of glass, including colored glass. U.S. Pat. No. 6,145,239, issued to Hirahara et al., discloses a soft bait lure having particles of glass material embedded therein, primarily in the lower half of the lure body. In addition, it is known to produce fishing lures using abalone shells to provide iridescence and spectral color variations. Abalone shells are known for producing gold, green, and violet appearances that shift to a multitude of different shades depending on the viewing angle.

While lures of the background art have proven somewhat successful in catching fish, there remains a need for an improved fishing lure having the ability to reflect and refract light in ways heretofore not achieved by the lures of the background art.

### BRIEF SUMMARY OF THE INVENTION

The present invention address the shortcomings and disadvantages present in the art by providing an improved fishing lure capable of presenting a unique visual impression by incorporation of a dichroic coating. The term “dichroic” refers to the property of having more than one color, especially when viewed from different angles or from transmitted to reflected light. Dichroic coated glass is produced by a process called “thin film physics” and is generally referred to as a color separator. To get this effect, thin layers of metallic oxides, such as titanium, silicon, and magnesium are deposited upon the surface of the glass in a high temperature, vacuum furnace. The present invention thus provides a fishing lure incorporating dicrhoic coatings that transmit certain wavelengths of light, while reflecting others, thus creating an interference-effect similar to the iridescence observed in nature's fire opal, dragonfly wings and hummingbird feathers. The transmitted color is different than the reflected color, and when the light rays transmit straight through the glass they are less effected by refraction than when passing at an off axis angle, which make the light travel a greater distance through the glass. It is this distance that causes a color shift. When dichroic glass is viewed at even slightly different angles, a variety of different colors are seen.

Accordingly, it is an object of the present invention to provide an improved fishing lure.

Another object of the present invention is to provide a fishing lure having improved reflective and light transmission characteristics.

Still another object of the present invention is to provide a fishing lure having an light interference-effect similar to the iridescence observed in nature.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of a fishing lure fabricated with dichroic glass; and

FIG. 2 is a cross-sectional view thereof taken along line 2-2 of FIG. 1.

### DETAILED DESCRIPTION OF THE INVENTION

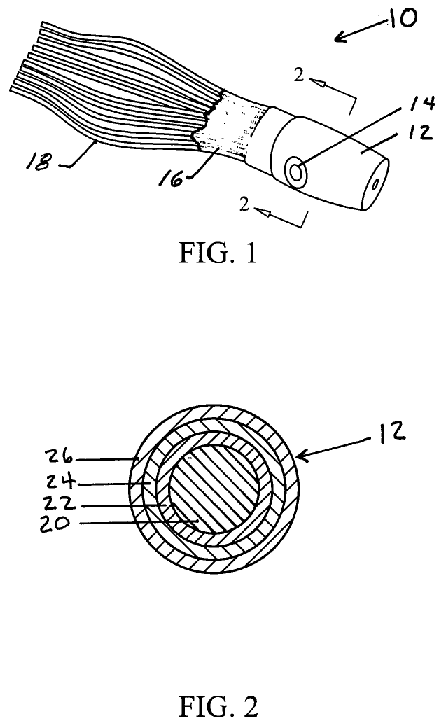

With reference now to the drawings, FIGS. 1 and 2 depict a fishing lure 10 fabricated with dichroic glass in accordance with the present invention. Fishing lure 10 comprises a trolling lure of the type commonly used when trolling for game fish. The overall shape of lure 10 is consistent with lures known in the prior art. Lure 10 includes a tapered, generally cylindrical body including a head 12 with a pair of circular eye-like structures 14. Connected to head 12 is a generally cylindrical tail section 16 having a plurality of streamer-like members 18. It should be noted that while the present invention is illustrated with a trolling lure that any suitable lure size and shape is considered within the scope of the present invention.

FIG. 2 is a cross-sectional view of the head 12 of lure 10 and specifically illustrates the advantageous structure presented by the use of dicrhoic glass. More particularly, lure 10 is preferably fabricated with a glass core 20. Core 20 is preferably fabricated of clear PYREX® glass, a substance having suitable strength and light reflecting characteristics. PYREX® is a trademark of Corning Incorporated or Corning N.Y. A layer of colored PYREX art glass, generally referenced as 22 is disposed in surrounding relation with core 20. Since fish respond to a wide range of colors the present invention contemplates that virtually any color, shade, or hue, of PYREX art glass may be used. Colored glass layer 22 is coated with a dichroic layer, referenced as 24, by a suitable application process. As discussed herein above, the dichroic layer provides an improved fishing lure that provides the appearance of having more than one color, especially when viewed from different angles or from transmitted to reflected light. The present invention is believed to be most suitable for use with trolling lures deployed at or near the surface, or other lures used at depths wherein sunlight penetrates.

Application of the dichroic coating 24 over PYREX® layer 22 may be achieved by any suitable process. For example, the dicrhoic coating may be applied by a process called “thin film physics”. According to this process thin layers of metallic oxides, such as titanium, silicon, and magnesium are deposited upon the surface of the PYREX® glass layer 22 and cured in a high temperature, vacuum furnace. Thin film dichroic coatings may be manufactured by a process known as Electron Bombardment Evaporation or E Beam Evaporation. According to this method, glass substrates are placed on rotation disks which spin in a planetary direction inside of a large thermal controlled vacuum chamber. At the base of the vacuum chamber there is a rotating multi crucible where minerals are loaded, below the crucible is a source used to heat and evaporate the minerals. The glass to be coated is carefully cleaned, and fastened to a planetary arm in the top of the chamber. The oxides are placed in a crucible on the bottom of the chamber. Air inside of the chamber is removed with a high vacuum-producing gyro-pump, and the chamber is heated to approximately 300 degrees Fahrenheit. The metallic oxides are vaporized by an electron beam, and the rotating glass target is evenly coated with many thin layers. The resulting color is determined by the individual oxide compositions and the coatings sequence, totaling about 700 angstroms thick, (3-5 millionths of an inch). Since the total thickness is so minute, the filter has very little mechanical integrity of its own and must be supported on a mechanically stable substrate. The present inventor has found that PYREX® glass provides a suitable substrate for the coating, as the glass is transparent, has adequate rigidity, is stable, withstands relatively high temperatures, and is not affected by moisture, solvents or most acids. As best illustrated in FIG. 2, lure 10 further includes an outer coating 26 of clear PYREX® that functions as a protective outer layer. Providing protective outer coating 26 in covering relation with dichroic layer 24 provides a protective layer to prevent scratching or damage.

The present invention thus provides a fishing lure incorporating dicrhoic coatings that transmit certain wavelengths of light, while reflecting others, thus creating an interference-effect similar to the iridescence observed in nature's fire opal, dragonfly wings and hummingbird feathers. The transmitted color is different than the reflected color, and when the light rays transmit straight through the glass they are less effected by refraction than when passing at an off axis angle, which make the light travel a greater distance through the glass. It is this distance that causes a color shift. When dichroic glass is viewed at even slightly different angles, a variety of different colors are seen. Fishing lures produced in accordance with the present invention thus present the distinct visual impressions as compared to prior art lures.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A fishing lure comprising:
a body having a central core;
a layer of colored glass in surrounding relation with said core;
a dichroic coating applied externally on said layer of colored glass; and
an outer layer of clear glass.

2. A fishing lure according to claim 1, wherein said colored glass comprises colored art glass.

3. A fishing lure comprising:
a rigid lure body formed about a glass core;
a layer of colored glass disposed in surrounding relation with said glass core;
a dichroic coating on said colored glass; and
a clear, light transparent exterior layer of glass in covering relation with said dichroic coating;
whereby said colored glass, said dichroic coating, and said clear exterior layer of glass cooperate to create a color shifting iridescent-effect when viewed from different angles.

4. A fishing lure according to claim 3, wherein said fishing lure comprises a salt water lure.

5. A fishing lure according to claim 3, wherein said fishing lure comprises a fresh water lure.
